(19) United States
(12) Patent Application Publication
(10) Pub. No.: US 2016/0237593 A1
(43) Pub. Date: Aug. 18, 2016

(54) TECHNIQUE FOR DETERMINING PARTICLE PROPERTIES

(71) Applicant: Stefan HORKOVICS-KOVATS, Radfeld (AT)

(72) Inventor: Stefan Horkovics-Kovats, Radfeld (AT)

(21) Appl. No.: 15/029,767

(22) PCT Filed: Oct. 16, 2014
(86) PCT No.: PCT/EP2014/072207

§ 371 Date: Apr. 15, 2016

(30) Foreign Application Priority Data
Oct. 17, 2013 (EP) 13005009.9

(51) Int. Cl. C40B 30/02; G06F 19/00

(52) U.S. Cl. CPC C40B 30/02; G06F 19/702

(57) ABSTRACT

A technique for estimating a dissolution property of particles released from a dosage form compacted from granular material is provided. The particles include an Active Pharmaceutical Ingredient, API. As to a method aspect of the technique, a dissolution time-profile, M_{measured}(t), for an amount of the API dissolved from the dosage form is measured. A reference dissolution time-profile, M(t), is determined by integrating a dissolution rate, dM(t)/dt, for the API. The dissolution rate depends on one or more parameters indicative of the dissolution property of the particles. The dissolution property of the particles is estimated by fitting the reference dissolution time-profile to the measured dissolution time-profile. The one or more parameters according to the fitted reference dissolution time-profile represent the estimated dissolution property.

### TECHNICAL FIELD

The present disclosure generally relates to a technique for determining properties of particles released from a dosage form. More specifically, and without limitation, the disclosure relates to a technique that determines physicochemical properties of the particles deliberated from the dosage form during a disintegration process, a development of the pharmaceutical dosage form, an in silico prediction of drug absorption influenced by manufacturing parameters of the dosage form based on the determined properties, establishing in vitro-in vivo correlation (IVIVC) based on the determined properties, and performing in silico equivalence studies based on the determined properties.

### BACKGROUND

Conventionally, dissolution time profiles of finish dosage forms (FDFs) are described in terms of an amount of substance dissolved up to a pre-defined time. Such characterizations are requirements for FDFs, e.g., by the U.S. Pharmacopeial Convention.

Besides the amount of substance dissolved up to a fixed time, a shape of the dissolution time-profiles has been described by means of a Weibull function. The Weibull function is described in Weibull W J, 1951, “A statistical distribution function of wide applicability”, J. Appl. Mech. 18:292-297. The dissolution time-profiles may also be described by comparing factors of difference (F₁) or similarity (F₂), as is disclosed in Moore J W, Flanner H H 1996, “Mathematical comparison of dissolution profiles”, Pharm. Technol. 20:64-74.

Currently, the dissolution properties of the FDFs are described preferentially under sink conditions, which is a drawback in view of an increasing development of FDFs containing Active Pharmaceutical Ingredients (APIs) that belong to the classes II and IV of the Biopharmaceutics Classification System (BCS). The biopharmaceutic drug classification is described in Amidon G L, Lennernas H, Shah V P, Crison J R 1995, “A theoretical basis for a biopharmaceutic drug classification: the correlation of in vitro drug product dissolution and in vivo bioavailability”, Pharm. Res. 12:413-420.

Generally, existing techniques for characterizing the dissolution time-profiles do not provide parameters directly reflecting the disintegration process of the FDF or the physicochemical properties of API particles enclosed in the formulation. It would be valuable to determine dissolution properties of the particles such as shape, mass, size and solubility.

Since currently employed techniques for dissolution time-profile analysis do not provide parameters related to the physicochemical properties of the API particles enclosed in the FDF, it is hardly possible to characterize and control the impact of the manufacturing process on the properties of an FDF in terms of its disintegration kinetics and physical properties of granular API particles enclosed herein. However, the knowledge of such properties is essential for assessing the effect on the drug bioavailability cause by changes in the manufacturing process of the FDF.

As a consequence, the conventional analysis may not provide sufficient information for a characterization of the FDF or its manufacturing process. Furthermore, the conventional analysis often has no or insufficient predictive value for the variability of drug absorption from an orally administered FDF.

### SUMMARY

Accordingly, there is a need for a technique that allows estimating properties of particles that are released after administration of a dosage form.

According to one aspect, a method of analyzing continuously or discretely measured dissolution time-profiles of a dosage form is provided, wherein the analysis extracts information about at least one of disintegration kinetics of the dosage form and physicochemical properties of particles released by the disintegration.

According to another aspect, a method of controlling a manufacturing process of a dosage form is provided, wherein an analysis of measured dissolution time-profiles provides feedback information as to an effect of the manufacturing process on at least one of disintegration kinetics for the dosage form and physicochemical properties of the particles released during the disintegration.

According to a further aspect, a method of assessing drug bioavailability of a dosage form is provided, wherein the assessment is based on an in silico-equivalence study employing Monte Carlo simulations that are based on an analysis of continuously or discretely measured dissolution time-profiles of a dosage form, wherein the analysis extracts information about at least one of disintegration kinetics of the dosage form and physicochemical properties of the particles released by the disintegration.

According to a still further aspect, a method of estimating a dissolution property of particles released from a dosage form compacted from granular material is provided. The particles include an Active Pharmaceutical Ingredient (API). The method comprises the steps of measuring a dissolution time-profile, M_{measured} (t), for an amount of the API dissolved from the dosage form; determining a reference dissolution time-profile, M(t), by integrating a dissolution rate, \dot{M}(t), for the API, wherein the dissolution rate depends on one or more parameters indicative of the dissolution property of the particles; and estimating the dissolution property of the particles by fitting the reference dissolution time-profile to the measured dissolution time-profile, wherein the one or more parameters according to the fitted reference dissolution time-profile represent the estimated dissolution property.

At least in some implementations of the method, the dissolution time-profile of the dosage form may implicitly contain information regarding the disintegration rate of the dosage form and/or the physicochemical properties of the particles released from the dosage form. Fitting the one or more parameters may allow extracting such information. In same or other implementations, the fitting of the time-profiles can provide at least one of kinetic properties of disintegration processes and parameters distinguishing between different mechanisms of the disintegration processes.

In at least some implementations, the method may allow extracting the information without requiring that the measured dissolution time-profile is measured under sink conditions. Same or other implementations may allow extracting the information even under circumstances when the API is not stable or the API particles have dimensions comparable with the diffusion layer thickness. Especially for APIs belonging to classes II and IV of the BCS, a measurement of the dissolution time-profiles may be difficult, when the requirement of sink conditions has to be fulfilled.

The method may thus, at least under certain conditions, allow determining the disintegration kinetics of a finish dosage form and physicochemical properties of particles that include the API and are distributed within the finish dosage form, based on the measured dissolution time-profile of the finish dosage form.

The dissolution property may be an intrinsic property of each of the particles. The dosage form may include a plurality of different particle types. Each of the particles may belong to one of a finite set of particle types. Different particles types may have different dissolution properties. The dissolution property may include an intrinsic dissolution time, T₀. The intrinsic dissolution time may be the time for dissolution of the particle in an infinite solvent volume. Alternatively or in addition, the dissolution property may include a dissolution factor, α, optionally for one or for each of the plurality of different particles types. The dissolution factor may depend on a surface roughness and/or surface geometry of a particle surface available for the dissolution of the particle.

The dissolution rate, \dot{M}(t), may be computed based on at least one of:
(a) a disintegration rate indicative of a rate at which the particles are disintegrated from the dosage form, and
(b) a particle mass indicative of a mass of a particle, wherein the particle mass at least temporarily decreases or increases after the disintegration of the particle, wherein the decrease or increase depends on the one or more parameters indicative of the dissolution property of the particles.

The particle mass may be a function of time, t. The particle mass may further be a function of a disintegration time, ξ. For example, the particle mass, m, may be a function of the form m(t,ξ). Alternatively or in combination, the particle mass may be parameterized by the particle type, p, and/or by any one of the one or more parameters, P. For example, the particle mass may be a function of the form mₚ(t,ξ) for different particle types p or m(P, t,ξ) for different particle types parameterized by the one or more parameters P. Preferably, the particle mass is parameterized by the intrinsic dissolution time T₀. For example, the particle mass may be a function of the form m(T₀, t,ξ). The intrinsic dissolution time T₀ is also referred to as a particle-intrinsic life-time. The particle mass may start decreasing or increasing at the time ξ of the disintegration.

Alternatively to aforementioned dissolution properties or in combination, the dissolution property may include an initial mass, m₀. The initial mass may be of the form m(ξ,ξ)=m₀, mₚ(ξ,ξ)=mₚ₀, or m(P,ξ,ξ)=m₀(P). For example, the initial mass may be m(T₀,ξ,ξ)=m₀(T₀). The one or more parameters may include the initial mass for one or for each of the plurality of different particles types.

The intrinsic dissolution time T₀, the dissolution factor α, and the initial mass m₀ may be related by

$${T}_{0} = \frac{3 {m}_{0}^{1 / 3}}{α} .$$

The intrinsic dissolution time T₀, the dissolution factor α, and the initial mass m₀ may be represented or representable by two parameters. The representation may use above relation.

The dissolution factor α may be computed according to

$$α = \frac{D}{δ} \frac{γ}{{ρ}^{2 / 3}} {c}_{s}$$

for a diffusion rate constant D, a thickness δ of the diffusion layer, a specific density ρ of the particle, a geometry factor γ, and a maximum solubility cₛ of the API.

The initial mass m₀ or the intrinsic dissolution time T₀ may be replaced, represented or determined by an initial volume V₀ as one of the parameters. The initial volume V₀ may be the particle volume at the time of disintegration. The intrinsic dissolution time T₀ may be related to the initial volume V₀ of the particles, or of one of the particle types, according to

$${T}_{0} = \frac{18 π ρ {V}_{0}^{1 / 3}}{{k}_{B} γ} \cdot \frac{η δ {R}_{0}}{{Tc}_{s}}$$

for a thickness δ of a diffusion layer, a specific density ρ of the disintegrated particle, a geometry factor γ of the disintegrated particle, a maximum solubility cₛ of the API, a hydrodynamic radius R₀ of molecules of the dissolved API, an absolute temperature T, and the Boltzmann constant k_{B}.

The parameters may include for each of the plurality of particle types one or more parameters indicative of the dissolution property of the corresponding one of the particle types. In at least some implementations, no more than one or two of the parameters may represent at least one of shape, size and state of aggregation for the particles or for each of the particle types.

Relative amounts, rₚ, may define relative rates, e.g., rₚ·v(ξ), at which particles of the different particle types p are released from the dosage form. The disintegration rate v(ξ) may define a total rate at which the particles are released, e.g., irrespective of their particle types. The disintegration rate may be expressed in terms of a decreasing volume of the dosage form, e.g., −∂V_{F}(ξ)/∂ξ, or in terms of a decreasing mass of the dosage form, −∂D_{F}(ξ)∂ξ. The fitting may also include varying the relative amounts rₚ of the different particle types p. The relative amounts rₚ may be at least substantially time-independent. The relative amounts rₚ may be independent of both the system time t and the dissolution time ξ.

The disintegration rate v(t) may be computed based on the measured dissolution time-profile M_{measured}(t). The disintegration rate v(t) may be computed according to

$$v ( t ) = \frac{{T}_{0} \dot{f} ( t )}{3} + {\int }_{0}^{t} \frac{2}{{T}_{0}} [ 1 - \frac{t - ξ - {\int }_{0}^{t} S ( ɛ ) d ɛ}{{T}_{0}} ] [ 1 - S ( t ) ] Θ ( t , ξ ) v ( ξ ) d ξ ,$$

wherein the particles released from the dosage form are at least substantially uniform. The disintegration rate v(t) may be computed according to

$$v ( t ) = \frac{\dot{f} ( t )}{{\sum }_{p = 1}^{L} \frac{3 {r}_{p}}{{T}_{{0}_{p}}}} + {\int }_{0}^{t} \frac{{\sum }_{p = 1}^{L} \frac{6 {r}_{p}}{{T}_{{0}_{p}}^{2}} [ 1 - \frac{t - ξ - {\int }_{ξ}^{t} S ( ɛ ) d ɛ}{{T}_{{0}_{p}}} ]}{{\sum }_{p = 1}^{L} \frac{3 {r}_{p}}{{T}_{{0}_{p}}}} [ 1 - S ( t ) ] {Θ}_{p} ( t , ξ ) v ( ξ ) d ξ ,$$

wherein the particles released from the dosage form include L different particles types, each of which is indicated by the index p. In each of above computations of the disintegration rate v(t), rₚ denotes the relative amount of the particle type p. A dimensionless function, S(t), may represent the measured dissolution time-profile M_{measured}(t). The dimensionless dissolution time-profile S(t) may be defined by

$$S ( t ) = \frac{{M}_{measured} ( t )}{{c}_{s} V} .$$

By setting, or assuming, a zero or neglectable degradation rate (k_{d}=0), a chemically stable API may be numerically represented. Alternatively, the degradation rate, k_{d}, may be a function of a pH value of a solvent.

A function, f(t), may include the dissolution rate dS/dt and degradation rate k_{d}. The rate f(t) may be defined by

$$f ( t ) = \frac{{c}_{s} V}{Dose} \frac{\dot{S} ( t ) + {k}_{d} S}{1 - S ( t )} ,$$

wherein “Dose” denotes the total amount of API in the dosage form.

The disintegration rate v(ξ) may be computed based on a time-discrete analysis of the measured dissolution time-profile M_{measured}(t) or S(t) according to

$$v ( i Δ t ) = \frac{\begin{matrix}g ( i Δ t ) {\sum }_{p = 1}^{L} \frac{{r}_{p}}{{T}_{{0}_{p}}} + 2 [ 1 - S ( i Δ t ) ] \\ {\sum }_{j = 0}^{i - 1} {\sum }_{p = 1}^{L} \frac{{r}_{p}}{{T}_{{0}_{p}}^{2}} [ 1 - \frac{i Δ t - j Δ t - {\sum }_{k = j}^{i} S ( k Δ t ) Δ t}{{T}_{{0}_{p}}} ] {Θ}_{p} ( i Δ t , j Δ t ) v ( j Δ t ) Δ t\end{matrix}}{{\sum }_{p = 1}^{L} \frac{{r}_{p}}{{T}_{{0}_{p}}} - {\sum }_{p = 1}^{L} \frac{{r}_{p}}{{T}_{{0}_{p}}^{2}} [ 1 - S ( i Δ t ) ] {Θ}_{p} ( i Δ t , j Δ t ) Δ t} ,$$

wherein

$$g ( i Δ t ) = \frac{\dot{f} ( i Δ t )}{{\sum }_{p = 1}^{L} \frac{3 {r}_{p}}{{T}_{0 p}}} .$$

A dissolution time, T₀+ΔT₀, of the disintegrated particles may be prolonged compared to the intrinsic dissolution time T₀. The prolongation may depend on the dissolved API according to

$$Δ {T}_{0} = {\int }_{ξ}^{{t}^{*}} S ( ɛ ) d ɛ ,$$

when the disintegrated particles are at least substantially uniform.

The prolongation may be computed according to

$$Δ {T}_{0 p} = {\int }_{ξ}^{{t}^{*}} S ( ɛ ) d ɛ$$

when the disintegrated particles include a plurality of different particle types p.

At least one of the following quantities may be numerically computed: a course of the disintegration rate, v(ξ), the disintegration rate at discretized times, v(i·Δt), the intrinsic dissolution time, e.g., T₀ or T₀ₚ, and the relative amounts, rₚ.

In combination with, or alternatively to, above computation based on the measured dissolution time-profile M_{measured}(t) or S(t), the disintegration rate v(ξ) may be computed based on a disintegration model.

The disintegration rate v(ξ) may be determined by a shape parameter, s, according to

$$v ( t ) = \{ \begin{matrix}0 , t < tlag \\ \frac{s \cdot exp [ - s \cdot ( t - tlag ) ]}{1 - exp [ - s \cdot td ]} \\ 0 , t \geq tlag + td\end{matrix} , tlag < t < tlag + td \} ,$$

wherein “tlag” may specify a lag time for releasing a particle from the dosage form and “td” may specify a duration for releasing a particle from the dosage form.

Alternatively, the disintegration rate v(ξ) may be determined by a plurality of release shape parameters, sₚ, according to

$$v ( t ) = \{ \begin{matrix}0 , & t < {tlag}_{p} \\ {\sum }_{p = 1}^{L} {r}_{p} \frac{{s}_{p} \cdot exp [ - {s}_{p} \cdot ( t - {tlag}_{p} ) ]}{1 - exp [ - {s}_{p} \cdot {td}_{p} ]} & {tlag}_{p} < t < {tlag}_{p} + {td}_{p} \\ 0 , & t \geq {tlag}_{p} + {td}_{p} \end{matrix} \} ,$$

wherein “tlagₚ” is a lag time for releasing a particle of type p from the dosage form and tdₚ is a duration for releasing a particle of type p from the dosage form.

One or more of the shape parameter, e.g., s or sₚ, the lag time, e.g., tlag or tlagₚ, and the duration, e.g., td or tdₚ, may be varied in the fitting. A value s·tdₚ>0 may represent a disintegration mechanism by surface erosion. A value s·tdₚ<0 may represent, e.g., disintegration by bulk erosion.

The computation of the sum of dissolution rate \dot{M}(t) and degradation term k_{d}·M(t) may be based on a product of the disintegration rate, v(ξ), and the decrease or increase, e.g., ∂m(t,ξ)/∂t, of the particle mass m(t,ξ), mₚ(t,ξ) or m(P, t,ξ).

The sum of dissolution rate \dot{M}(t) and degradation term k_{d}·M(t) may be computed based on a product of the disintegration rate v(ξ) and the decrease or increase ∂m(t,ξ)/∂t of the particle mass m(t,ξ) according to

$$\dot{M} ( t ) + {k}_{d} M ( t ) = - {\int }_{0}^{t} {N}_{0} \frac{\partial m ( t , ξ )}{\partial t} v ( ξ ) d ξ ,$$

e.g., when the particles released from the dosage form are at least substantially uniform.

The decrease ∂m(t,ξ)/∂t of the particle mass m(t,ξ) may be computed according to

$$\frac{\partial m ( t , ξ )}{\partial t} = - {am}^{2 \text{/} 3} ( t , ξ ) [ 1 - \frac{M ( t )}{{c}_{s} V} ] ,$$

wherein cₛ denotes a maximum solubility of the API and V denotes a solvent volume.

Alternatively or in addition, e.g., if a characteristic dimension of the particle is (e.g., temporarily) comparable with (e.g., equal to or less than) the thickness 8 of a diffusion layer, afore-mentioned equation may be modified according to

$$\frac{\partial m ( t , ξ )}{\partial t} = - a \cdot {m}^{2 \text{/} 3} ( t , ξ ) [ 1 + \frac{β}{{m}^{1 \text{/} 3} ( t , ξ )} - \frac{M ( t )}{c ( ∞ ) \cdot V} ] ,$$

wherein

$$a = {k}_{1} ( ∞ ) \frac{{f}_{A}}{{( {f}_{V} \cdot ρ )}^{2 \text{/} 3}} , β = δ \cdot {( {f}_{V} \cdot ρ )}^{1 \text{/} 3} , c ( ∞ ) = \frac{{k}_{1} ( ∞ )}{{k}_{2}} ,$$

with k₁(∞) being the dissolution rate of a plane surface, δ is the thickness of a diffusion layer, k₂ is the crystallization rate, f_{A} is a surface factor (e.g., so that: A=f_{A}·r²), and f_{V} is a volume factor (e.g., so that: m=V·ρ=f_{V}·r³·ρ).

Alternatively, the sum of dissolution rate \dot{M}(t) and degradation term k_{d}·M(t) may be computed based on a product of the disintegration rate v(ξ) and the decrease or increase ∂m(t,ξ)/∂t of the particle mass according to

$$\dot{M} ( t ) + {k}_{d} M ( t ) = - {\int }_{o}^{t} {\sum }_{p = 1}^{L} {N}_{p 0} \frac{\partial {m}_{p} ( t , ξ )}{\partial t} v ( ξ ) d ξ ,$$

e.g., when each of the particles released from the dosage form is at least substantially represented by one of a plurality of L particle types.

The decrease ∂mₚ(t,ξ)/∂t of the particle mass mₚ(t,ξ) may be computed for one or each of the particle types according to

$$\frac{\partial {m}_{p} ( t , ξ )}{\partial t} = - α {m}_{p}^{2 \text{/} 3} ( t , ξ ) [ 1 - \frac{M ( t )}{{c}_{s} V} ] ,$$

wherein α denotes a dissolution factor common for all particles, and mₚ denotes the initial mass of the particle type p among the plurality of L particle types.

Alternatively, the change, e.g. the decrease, ∂mₚ(t,ξ)/∂t of the particle mass mₚ(t,ξ) may be computed for one or each of the particle types according to

$$\frac{\partial {m}_{p} ( t , ξ )}{\partial t} = - {α}_{p} {m}_{p}^{2 \text{/} 3} ( t , ξ ) [ 1 - \frac{M ( t )}{{c}_{s} V} ] ,$$

wherein mₚ denotes the initial mass of the particle type p among the plurality of L particle types and αₚ denotes a dissolution factor for the particle type p among the plurality of L particle types. The different particle types may include different shapes of particles including the same API.

Alternatively or in addition, e.g., if a characteristic dimension for one or all particle types is (e.g., temporarily) comparable with (e.g., equal to or less than) the thickness of a diffusion layer, afore-mentioned equation may be modified according to

$$\frac{\partial {m}_{p} ( t , ξ )}{\partial t} = - {α}_{p} {m}_{p}^{2 \text{/} 3} ( t , ξ ) [ 1 + \frac{{β}_{p}}{{m}_{p}^{1 \text{/} 3} ( t , ξ )} - \frac{M ( t )}{{c}_{p} ( ∞ ) V} ] ,$$

wherein the subindex p indicates the particle type, and wherein

$${a}_{p} = {k}_{p , 1} ( ∞ ) \frac{{f}_{p , A}}{{( {f}_{p , V} \cdot {ρ}_{p} )}^{2 \text{/} 3}} , {β}_{p} = {δ}_{p} \cdot {( {f}_{p , V} \cdot {ρ}_{p} )}^{1 \text{/} 3} , {c}_{p} ( ∞ ) = \frac{{k}_{p , 1} ( ∞ )}{{k}_{p , 2}} ,$$

with k_{p,1}(∞) being the dissolution rate of a plane surface, δₚ is the thickness of a diffusion layer, k_{p,2} is the crystallization rate, f_{p,A} is the surface factor (e.g., so that: Aₚ=f_{p,A}·rₚ²), and f_{p,V} is the volume factor (e.g., so that: mₚ=Vₚ·ρₚ=f_{p,V}·rₚ³·ρₚ).

The particle types may distinguish various polymorphic forms. Each particle type, e.g., each of the polymorphic forms, may be associated with a solubility cₚ(∞).

The sum of dissolution rate \dot{M}(t) and the degradation term k_{d}·M(t) may be computed based on a product of the disintegration rate, −∂V_{F}(ξ)/∂ξ, and the decrease or increase ∂m(P,t,ξ)/∂t of the particle mass according to

$$\dot{M} ( t ) + {k}_{d} M ( t ) = - {\int }_{0}^{t} d ξ {\int }_{0}^{∞} d P n ( P , ξ ) \frac{\partial {V}_{F} ( ξ )}{\partial ξ} \frac{\partial m ( P , t , ξ )}{\partial t} ,$$

wherein the decrease or increase of the particle mass is parameterized by at least one of the one or more parameters P, optionally by the dissolution time, i.e., P=T₀.

A dimensionless disintegration rate may be computed from the disintegration rate, −∂V_{F}(ξ)/∂ξ, according to

$$v ( t ) = - \frac{1}{{V}_{dosage}} \frac{\partial {V}_{F} ( t )}{\partial t} .$$

The change (e.g., the decrease), e.g., ∂m(t,ξ)/∂t, of the particle mass m(t,ξ), mₚ(t,ξ) or m(P,t,ξ) (e.g., m(T₀,t,ξ)) may be reduced or increased as the amount of API dissolved according to the reference dissolution time-profile M(t) increases or decreases, e.g., to its maximum value.

The API degradation rate, k_{d}, may be a function of a pH value of a solvent.

The fitting may include any one of the steps of:
comparing the measured dissolution time profile and the reference dissolution time profile;
adjusting the one or more parameters based on a result of the comparison to reduce a deviation between the measured dissolution time profile and the reference dissolution time profile; and
repeating the steps of determination, comparison and adjustment until the result of the comparison is indicative of a matching criterion.

The method may further comprise the step of evaluating an Akaike information criterion (AIC) for different complexities of the reference dissolution time-profile. The complexity may include a number L of the plurality of particle types. The different complexities may include different numbers of the parameters indicative of the dissolution property of the particles. The complexity that minimizes the AIC may be used for the estimation of the dissolution property.

Alternatively or in addition to the Akaike information criterion, the optimization may aim at maximization of a likelihood criterion.

The parameters may be the same for each of the disintegrated particles of the same particle type. The method may further comprise the step of computing a distribution of at least one of the parameters, e.g., according to r(P) for a continuous distribution of particle types or according to rₚ=Nₚ₀/(Σ^{L}ₚ₌₁Nₚ₀) for discrete particle types. Preferably, the continuous distribution, n₀(T₀), of particle types may be parameterized according to P=T₀.

According to a still further aspect, a method of manufacturing a dosage form is provided. The dosage form is compacted from granular material. The manufacturing method comprises the steps of compressing the granular material into the dosage form according to a compression parameter; estimating a dissolution property of particles released from the dosage form according to any one of above method aspects; and repeating at least the step of compression using a modified compression parameter, wherein the compression parameter is modified based on the estimated dissolution property.

The compression parameter may be modified to reduce a deviation between the estimated dissolution property and a predefined dissolution property.

The manufacturing method may further comprise the step of determining a change in particle size distribution due to the compression by comparing an initial particle size distribution of the granular material with a final particle size distribution that is consistent with the estimated dissolution property. The particle size may determined by the initial volume, V₀, e.g., according to any one of above relations including the initial volume V₀.

According to a still further aspect, a computer-implemented method of assessing equivalence between a dosage form and a given second dosage form is provided. The method comprises the steps of providing a Physiologically Based Pharmacokinetic (PBPK) model; and estimating a dissolution property of particles released from the dosage form according to any one of above method aspects, wherein the measured dissolution time-profile M_{measured}(t) is incompletely represented by one or more measured plasmatic time-profiles for the given second dosage form, and wherein the reference dissolution time-profile M(t) is computed under conditions defined by the PBPK model.

The PBPK model may include a fluid intake regime. The reference dissolution time-profile M(t) may be computed for the fluid intake regime. The PBPK model may specify pH values and residence times of the fluid intake regime. The dissolution property may be estimated for different combinations of pH values and residence times of the fluid intake regime.

The different pH values may change the drug solubility and at least one of the dissolution factor α, the intrinsic dissolution time T₀, and the API degradation rate k_{d}. The change may be computed according to any one of above relations including the drug solubility, dissolution factor α, the intrinsic dissolution time T₀, and the API degradation rate k_{d}, respectively.

The method may further comprise the step of computing one or more Test to Reference values for the different combinations. At least one of a confidence interval and a coefficient of variance for the Test of Reference values may be computed.

The confidence interval or the coefficient of variance may be computed by means of a Monte Carlo simulation that varies at least one of the pH values, the residence times, an availability of fluid downstream of the fluid intake regime, absorption rates, elimination rates, and distribution volumes of the PBPK model.

Any one of above methods may be entirely computer-implemented.

### BRIEF DESCRIPTION OF THE DRAWINGS

Further features and advantageous of the technique presented herein are described herein below by means of embodiments with reference to the accompanying drawings, in which:

FIG. 1 is a plot showing examples for a given disintegration rate function and a determined disintegration rate function;

FIG. 2 is a plot showing an exemplary evaluation of the Akaike information criterion;

FIG. 3 is a plot showing an assessment of the quality of particle determination based on the results shown in FIGS. 1 and 2;

FIG. 4 is a flowchart of a method of estimating a Particle Life-time Distribution (PLD) as an example of a dissolution property;

FIG. 5 is a plot showing a dissolution time-profile for a Test formulation and for a Reference formulation;

FIG. 6 is a graphical representation of results of a disintegration and dissolution analysis;

FIG. 7 is a block diagram schematically illustrating a Physiologically Based Pharmacokinetic (PBPK) model;

FIG. 8 includes two plots each showing measured and predicted mean clarithromycin plasma concentrations following an oral administration of a 500 mg immediate release tablet for a test formulation and a reference formulation, respectively;

FIG. 9 includes a left plot illustrating a time curve of a volume of fluid in a stomach and a right plot illustrating an amount of fluid in an absorption window for an exemplary case of administrating water to the subjects;

FIG. 10 illustrates a relation of AUC values on stomach pH between 0.4 and 3.6 and stomach residence time between 5 to 45 minutes as Test to Reference ratio;

FIG. 11 shows a diagram for the lifetime of particles as a function of initial mass; and

FIG. 12 shows a diagram for a dissolution rate as a function of the particle mass.

### DETAILED DESCRIPTION

In the following description, for purposes of explanation and not limitation, specific details are set forth, such as particular numerical examples, in order to provide a thorough understanding of the technique presented herein. It will be apparent to one skilled in the art that the present technique may be practiced in other embodiments that depart from these specific details.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP) or general purpose computer. It will also be appreciated that while the following embodiments are described in the context of methods and devices, the technique presented herein may also be embodied in a computer program product as well as in a system comprising a computer processor and a memory coupled to the processor, wherein the memory is encoded with one or more programs that execute the services, functions and steps disclosed herein.

The estimation and analysis is described in what follows for a continuously measured dissolution time-profile. First, homogeneous particles that are uniformly distributed in the FDF are considered.

Let us consider a particle of the p-th kind of particles having a mass mₚ at time t, which was released from the FDF at time. Due to dissolution it changes its mass according to

$$\frac{\partial {m}_{p} ( t , ξ )}{\partial t} = - α {m}_{p}^{2 / 3} ( t , ξ ) [ 1 - \frac{M ( t )}{{c}_{s} V} ] ,$$

wherein α is a particle shape-dependent dissolution rate. To terminologically distinguish between the factor α as a particle property and the total dissolution rate \dot{M}(t), the factor α is also referred to as a dissolution factor. Further details on the dissolution factor α are provided in Horkovics-Kovats S, 2004, “Characterization of an active pharmaceutical ingredient by its dissolution properties: amoxicillin trihydrate as a model drug”, Chemotherapy, 50:234-244. The symbol M denotes the amount of drug having a solubility of cₛ, dissolved in the medium of volume V Time needed for particle to be totally dissolved in infinite volume calling intrinsic life time of the particle is

$${T}_{0 p} = \frac{3 {m}_{0 p}^{1 / 3}}{α} .$$

When assigning M(t)/(cₛ*V) as saturation state function S(t), the time dependence of the mass of the considered particle is expressed as

$${m}_{p} ( t , ξ ) = \{ \begin{matrix}{m}_{0 p} , & t ∈ [ 0 , ξ ) \\ {{m}_{0} [ 1 - \frac{t - ξ - {\int }_{ξ}^{t} S ( ɛ ) d ɛ}{{T}_{0 p}} ]}^{3} , & t ∈ [ ξ , {t}^{*} ] \\ 0 , & t > {t}^{*}\end{matrix} ,$$

wherein at time t* the particle released from the FDF at time will be totally dissolved.

For the analysis of a continuous measured dissolution time-profile, above-derived equations result in a Volterra integral equation of first kind:

$$\frac{{c}_{s} V}{Dose} \frac{\dot{S} ( t ) + {k}_{d} S}{1 - S ( t )} = {\int }_{0}^{t} {\sum }_{p = 1}^{L} {\frac{3 {r}_{p}}{{T}_{p}} [ 1 - \frac{t - ξ - {\int }_{ξ}^{t} S ( ɛ ) d ɛ}{{T}_{0 p}} ]}^{2} {Θ}_{p} ( t , ξ ) v ( ξ ) d ξ ,$$

wherein rₚ is the relative amount of dose, Dose; distributed into the p-th type of particles. Introducing the function

$${Θ}_{p} ( t , ξ ) = \{ \begin{matrix}1 , & t - ξ - {\int }_{ξ}^{t} S ( ɛ ) d ɛ < {T}_{0 p} \\ 0 , & t - ξ - {\int }_{ξ}^{t} S ( ɛ ) d ɛ \geq {T}_{0 p}\end{matrix} ,$$

only the solution with physical meaning is considered.

The properties of the function and kernel of the above presented Volterra integral equation of the first kind allow converting it to a Volterra equation of second kind, which has in this particular case continuous and unique solution for the function v(t), cf. inter alia Linz P, 1985, “Linear Volterra equations of the second kind. Analytical and Numerical Methods for Volterra Equations”, p. 29-50.

The solution has the form:

$$v ( t ) = \frac{\dot{f} ( t )}{{\sum }_{p = 1}^{L} \frac{3 {r}_{p}}{{T}_{0 p}}} + {\int }_{0}^{t} \frac{{\sum }_{p = 1}^{L} \frac{6 {r}_{p}}{{T}_{0 p}^{2}} [ 1 - \frac{t - ξ - {\int }_{ξ}^{t} S ( ɛ ) d ɛ}{{T}_{0 p}} ]}{{\sum }_{p = 1}^{L} \frac{3 {r}_{p}}{{T}_{0 p}}} [ 1 - S ( t ) ] {Θ}_{p} ( t , ξ ) v ( ξ ) d ξ ,$$

wherein

$$f ( t ) = \frac{{c}_{s} V}{Dose} \frac{\dot{S} ( t ) + {k}_{d} S}{1 - S ( t )} .$$

This equation is solved, e.g., using Gordis and Neta approximation. Further details of this general approximation technique are published by Gordis J H, Neta B, 2000, “An adaptive method for the numerical solution of Volterra integral equations”, in Mastorakis N, (editor), Athens, Greece: World Scientific and Engineering Society International Conference, p 1-8.

The disintegration rate is approximately computed according to:

$$v ( i Δ t ) = \frac{g ( i Δ t ) {\sum }_{p = 1}^{L} \frac{{r}_{p}}{{T}_{0 p}} + 2 [ 1 - S ( i Δ t ) ] {\sum }_{j = 0}^{i - 1} {\sum }_{p = 1}^{L} \frac{{r}_{p}}{{T}_{0 p}^{2}} [ 1 - \frac{\begin{matrix}i Δ t - j Δ t - \\ {\sum }_{k = j}^{i} S ( k Δ t ) Δ t\end{matrix}}{{T}_{0 p}} ] {Θ}_{p} ( i Δ t , j Δ t ) v ( j Δ t ) Δ t}{{\sum }_{p = 1}^{L} \frac{{r}_{p}}{{T}_{0 p}} - {\sum }_{p = 1}^{L} \frac{{r}_{p}}{{T}_{0 p}^{2}} [ 1 - S ( i Δ t ) ] {Θ}_{p} ( i Δ t , j Δ t ) Δ t} , \qquad ( Eq . PF )$$

wherein

$$g ( i Δ t ) = \frac{\dot{f} ( i Δ t )}{{\sum }_{p = 1}^{L} \frac{3 {r}_{p}}{{T}_{0 p}}} .$$

The above method of calculating the disintegration rate function v(t) out of the continuously measured saturation state function S(t) is in the further part of the description assigned as procedure F. This procedure serves for calculation of the disintegration rate of an FDF, when the particle size distribution of API particles present in the formulation is discretized into L discrete kinds of particles, each characterized by its relative amount rₚ and intrinsic life time T₀ₚ, wherein

$${\sum }_{p = 1}^{L} {r}_{p} = 1.$$

On the other hand, for any disintegration rate function v(t) describing the release of p=1, 2, . . . , L-kinds of particles from the FDF, the dissolution time profile of the system is determined by the procedure G as follows:

for t≧ξ
if mₚ(t,ξ)>−αmₚ (t,ξ)^{2/3}[1−S(t)]dt then dmₚ (t,ξ)=−αmₚ (t,ξ)²³ [1−S(t)]dt
else dmₚ(t,ξ)=−mₚ(t,ξ)

$$\frac{d M ( t )}{d t} = - {\int }_{0}^{t} {\sum }_{p = 1}^{L} {N}_{p} ( ξ ) \frac{\partial m ( t , ξ )}{\partial t} d ξ - {k}_{d} M ,$$

where introducing the rate constant k_{d} the degradation of the API during the dissolution experiment is introduced, further

$$dS ( t ) = \frac{dM ( t )}{{c}_{s} V} ,$$

and Nₚ(ξ)=ₚ₀ν(ξ), fulfilling

$$Dose = {\sum }_{p = 1}^{L} {r}_{p} {N}_{p 0} {m}_{p 0}$$

and initial conditions: M(0)=0, S(0)=0 and for t<ξmₚ(t,ξ)=mₚ₀.

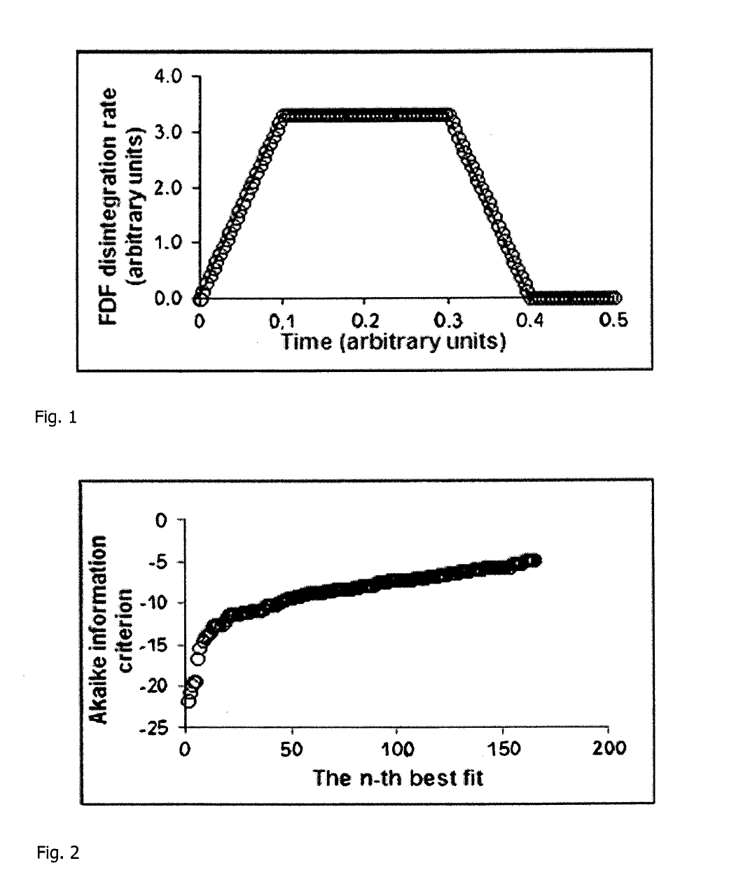

Taking the disintegration rate

$$v ( ξ ) = \{ \begin{matrix}\frac{16 ξ}{3 {ξ}^{* 2}} , & 0 \leq ξ \leq \frac{{ξ}^{*}}{4} \\ \frac{4}{3 {ξ}^{*}} , & \frac{{ξ}^{*}}{4} \leq ξ \leq \frac{3 {ξ}^{*}}{4} \\ \frac{16}{3 {ξ}^{* 2}} ( {ξ}^{*} - ξ ) , & \frac{3 {ξ}^{*}}{4} \leq ξ \leq {ξ}^{*} \\ 0 , & ξ > {ξ}^{*}\end{matrix} \} ,$$

wherein ξ* the time of complete disintegration of the formulation, the dissolution time profile for an FDF containing L=3 kinds of particles was calculated using procedure G. This dissolution time profile was analyzed by procedure F to demonstrate the ability of this procedure to determine the disintegration of an FDF. The result is shown on FIG. 1.

FIG. 1 provides numerical examples for given and determined disintegration rate functions. Using the presented method, the disintegration rate of an FDF was determined from the theoretical data set generated by a system of differential equations according to the procedure G. The solid line in FIG. 1 indicates the given disintegration rate function used for the procedure G. Circles in FIG. 1 indicate a disintegration rate function determined according the procedure F.

The determinability of the physicochemical properties of the particles and the disintegration rate function were evaluated under various conditions (with doses resulting in values of Sat infinity equaling to 0.01; 0.3; 0.5; 0.8 and 0.99). Employing under- or over-parameterized models (those containing less or more particle kinds then used for calculation of the saturation state function S(t)) was evaluated for different initial conditions of the parameters. The models were compared using Akaike information criterion and result shown on FIG. 2. Details of the Akaike information criterion are published in Akaike H, 1974, “A new look at the statistical model identification”, IEEE Transactions on Automatic Control, 19:716-723.

FIG. 2 is a plot showing an evaluation of the Akaike information criterion. FDF models of various complexity are analysed according to above-described technique assuming a number L of 2, 3, 4 and 5 kinds of particles. The resulting dissolution time-profiles were fitted to target dissolution time-profiles calculated for disintegrating FDF containing L=3 kinds of particles and reaching the value of the saturation state function at infinity of 0.01, 0.3, 0.5, 0.8 and 0.99, respectively. In order to make the fittings comparable, the saturation state functions were expressed as S(t)/S(∞)*100, wherein S(t) is the saturation state function at time t and S(∞) is its value at infinity. The Akaike information criterion (AIC) was calculated as

$$AIC = ln ( \frac{{\sum }_{N}^{ } {( {x}_{i} - {y}_{i} )}^{2}}{N - 1} ) + 2 \frac{{N}_{p} - 1}{N} ,$$

wherein xᵢ represents the value of i-th time point of the fitted curve, yᵢ that of the theoretical curve, N is the number of observations and Nₚ is the number of parameters used in the model.

Evaluating the first 25 best fits revealed that sink conditions are not essential for a proper determination of the intrinsic life-time of particles, since 16%, 28%, 16%, 12% and 28% of the fits belonged to dosing groups resulting 1%, 30%, 50%, 80% and 99% of the saturation state at infinity, respectively. The first 12 best fits were identifying the proper complexity of the model (employing 3 particle type models).

Only 32% of the best 25 fits used over-parameterized FDF models (4 or 5 particle types).

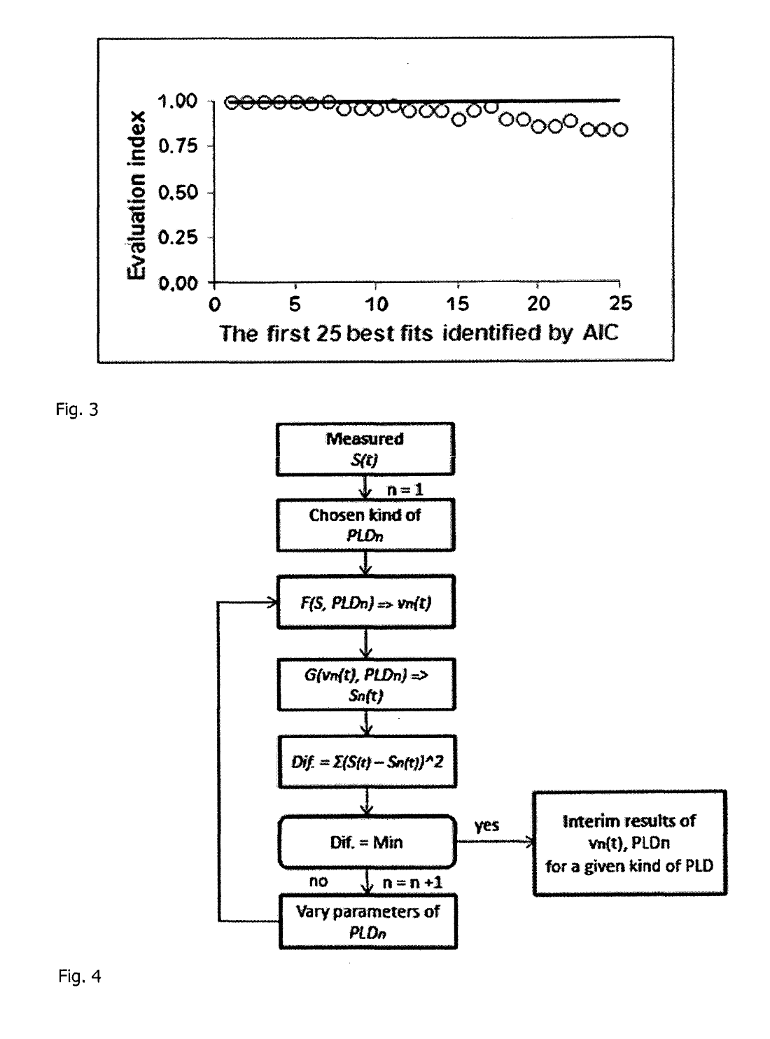

The first 25 best fits were further evaluated regarding the accuracy of both parameters, i.e. the correct intrinsic life-time of particles and their relative amount in the formulation. Since the over-parameterized FDF models used more than the correct number of particle types, the evaluation was made using an evaluation index (for more details, see the legend to FIG. 3). FIG. 3 shows that the five best fits determine precisely both the particle intrinsic life-times and their relative amount in the FDF.

FIG. 3 is a plot showing a quantitative assessment of the quality of particle determination. The evaluation index, EI, was calculated as

$$EI = {\prod }_{i = 1}^{L} \{ {\sum }_{j = 1}^{{n}_{i}} \frac{{u}_{i , j}}{{w}_{i}} [ 1 - abs ( 1 - \frac{{Y}_{ij}}{{T}_{i}} ) ] \} ,$$

wherein Tᵢ is the i-th particle intrinsic life-time of the target distribution, Yᵢⱼ is the j-th intrinsic life-time value determined by fitting in the proximity of the i-th correct intrinsic life-time, wᵢ is the relative amount of dose having the correct intrinsic life-time Tᵢ and uᵢⱼ is the determined relative amount of particles having an intrinsic life-time of Yᵢⱼ; and finally nᵢ represents the number of identified particle kinds in the neighborhood of the i-th particle kind. FIG. 3 shows the evaluation indexes of the best 25 fitting results. These results were allocated to the 5 dosing groups as follows: 4, 7, 4, 3 and 7 cases in doses reaching 1%, 30%, 50%, 80% and 99% of maximal drug solubility at the end of dissolution process, respectively, indicating no preference for sink conditions.

The process of determining the disintegration rate function and physicochemical properties of the particles is summarized on FIG. 4.

FIG. 4 schematically represents the procedure leading to assessment of the disintegration rate function v(t) and the particle life-time distribution (PLD). To a measured saturation state function S(t) and a chosen kind of PLD by employing the procedure F the disintegration rate function is calculated. Then to the determined disintegration rate function and the given PLD using a procedure G, a theoretical saturation state function Sₙ(t) is determined. The difference between the functions S(t) and Sₙ(t) is calculated. By changing the initial conditions and the parameters of the PLD the difference between the functions S(t) and Sₙ(t) is minimized. For the found conditions the disintegration rate function v(t) and PLD reflect interim results. The final disintegration rate function and PLD, are found by evaluating the various PLD models based e.g. on the Akaike information criterion. The procedure F represents a calculation of the function v(t) expressed from Eq. (PF), and the procedure G represents the solution of a system of differential equations describing the dissolution of particles having a given intrinsic life-time distribution PLD, which enter the dissolution medium according to function v(t).

Clearly, the presented procedure is valid also for uniform particles, in which case the number of particle types in the procedure F is equal to L=1. It is pointed out that for proper determination of the disintegration rate function by using procedure F, a very small time step has to be chosen. This causes together with the number of assumed particle kinds very large multidimensional numeric arrays, and consequently the need of large memory capacities and long computation times together with the requirement of almost continuous measurement of the dissolution profiles. Further it has to be noted that any particle size distribution of particles in the FDF can be expressed as discrete particles, hence any PSD can be also expressed using p=1, 2, . . . , L kind of particles each having its particular intrinsic life time value and hence the above procedure F can be applied to its dissolution time profile.

A method of analyzing a discretely measured dissolution time profile is described in what follows. First, particles that follow one PSD and are uniformly distributed in the FDF are considered.

Surprisingly, when analyzing the disintegration rates of FDFs having various forms (spherical, brick form, cylinder form) with different ratios of the shape parameters and different rates of disintegration along their axis, all theoretically determined disintegration rate functions can be approximated as indicated in further below Table 1 with high correlation (r2>0.99) to the function expressing the rate of FDF disintegration as:

$$v ( t ) = \{ \begin{matrix}0 , & t < {t}_{lag} \\ \frac{s exp [ - s ( t - {t}_{lag} ) ]}{1 - exp ( - {st}_{d} )} , & {t}_{lag} \leq t < {t}_{d} + {t}_{lag} \\ 0 , & {t}_{d} + {t}_{lag} \leq t\end{matrix} \} ,$$

wherein t_{lag} is the lag time of the start of disintegration (important e.g. in case of film-coated FDFs), s is a shape parameter and t_{d} is the duration of the disintegration process.

This feature enables to extract the FDF disintegration rate and the physicochemical properties of the API particles, when assuming a particular PSD, from a limited number of measured time points, even under conditions when a degradation of the API takes place during the dissolution measurement.

Assuming spherical particles with volume V=6/π*d³ with a mass distribution following e.g. a log/normal distribution N≈(μ,σ²), where μ=ln(V_{0.5}).

The discretization of this continuous distribution into L segments, each containing the same amount of dose (Dose/L) is performed as follows: first the distribution may be transformed into a standard normal distribution N≈(0,1) using the transformation

$$z = \frac{ln ( V ) - μ}{σ}$$

and the thresholds of the segments may be calculated by solving of the equation:

$$\frac{1}{\sqrt{2 π}} {{\int }_{- ∞}}^{{z}_{p}} exp ( - 0.5 {z}^{2} ) d z = \frac{p}{L} ,$$

for p=0, 1, 2, 3, . . . , L−1. The mean volume of particles in the p-th segment for p=1, 2, 3, . . . , L, located between thresholds zₚ₋₁ and zₚ, may then be determined by the integral

$${\overline{z}}_{p} = \frac{1}{\sqrt{2 π}} {{\int }_{{z}_{p - 1}}}^{{z}_{p}} z exp ( - 0.5 {z}^{2} ) d z$$

resulting for

$$p = 1 {\overline{z}}_{1} = - \frac{1}{\sqrt{2 π}} exp ( - 05 {z}_{1}^{2} ) , for p = 2 , 3 , … , L - 1$$

$${\overline{z}}_{p} = - \frac{1}{\sqrt{2 π}} [ exp ( - 0.5 {z}_{p}^{2} ) - exp ( - 0.5 {z}_{p - 1}^{2} ) ] , \\ and finally for p = L \text{:} {\overline{z}}_{L} = \frac{1}{\sqrt{2 π}} exp ( - 0.5 {z}_{L - 1}^{2} ) .$$

In each segment the particles may be approximated with Nₚ particles having a mass equaling to the expected mass mₚ. For the expected mass of particles and their number Np and in the p-th segment may result:

$${m}_{p} = ρexp ( {\overline{z}}_{p} σ + μ )$$

$$and$$

$${N}_{p} = \frac{Dose}{{Lm}_{p}} = \frac{Dose}{L ρ} exp [ - ( {\overline{z}}_{p} σ + μ ) ] ,$$

respectively.

Changing the parameters in the procedure G (e.g., μ, σ, k_{d}, s, t_{lag}, t_{d}, and, when applicable, cₛ), the predicted dissolution profile is fitted to the measured data points by minimizing the sum of error squares.

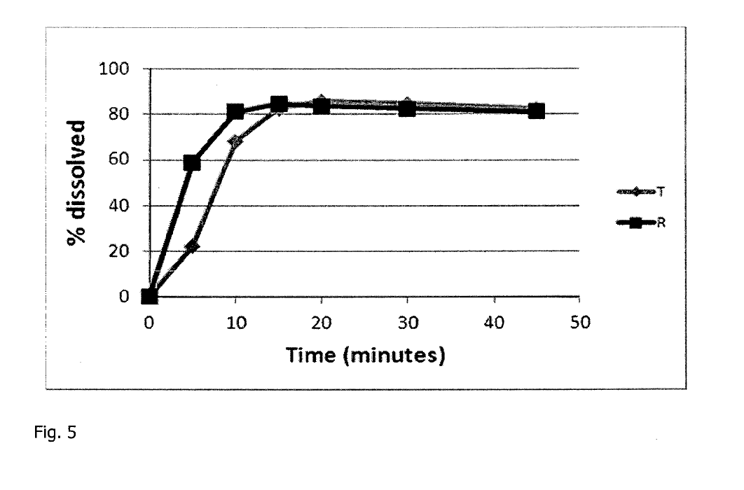

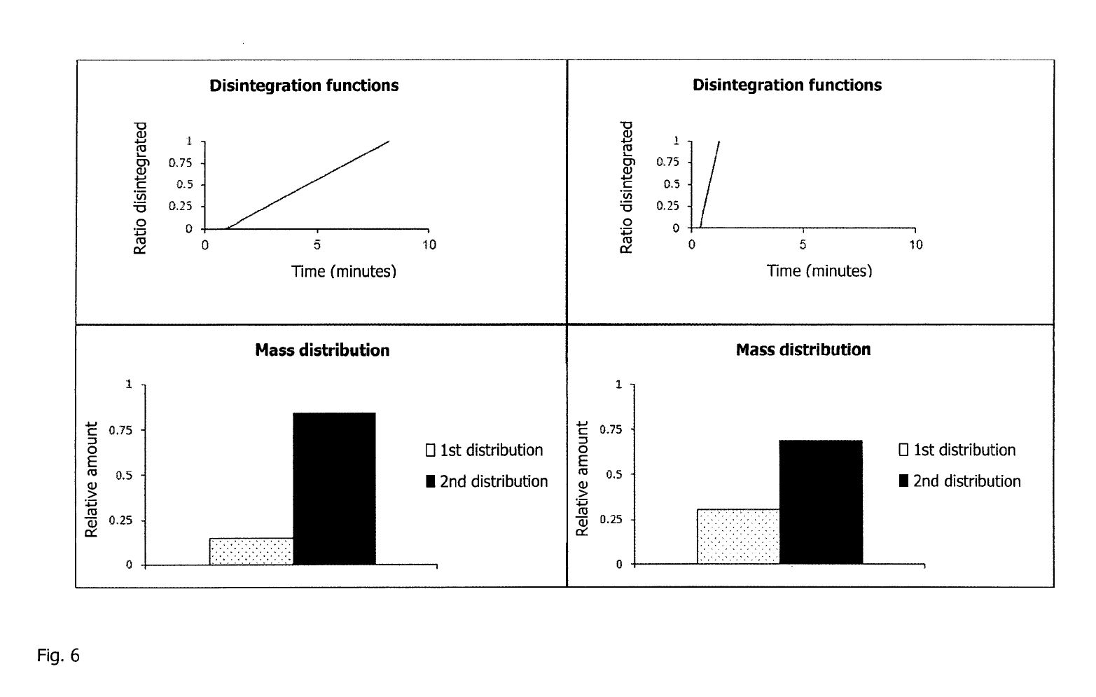

In the presented example, it is assumed that a homogeneous distribution of two kinds of particles each following a log/linear particle size distribution. Performing the procedure G, the discretely measured values of 500 mg immediately release Clarithromycin tablets (which is used in the plot of FIG. 5) reveal the FDF properties shown in FIG. 6.

FIG. 5 shows dissolution profiles of Test and Reference formulations. Gray symbols indicate measured data points of the test formulation, and black symbols indicate measured data points of the reference formulation. The data is published by Lohitnavy M, Lohitnavy O, Wittaya-areekul S, Sareekan K, Polnok S, Chiyaput W 2003, “Average bioequivalence of clarithromycin immediate released tablet formulations in healthy male volunteers”, Drug Dev Ind Pharm, 29:653-659.

The lines in FIG. 5 represent the calculated dissolution time profiles employing above-described model for the disintegration rate v and for the particular case of homogeneously distributed particles belonging to two log/linear normal particle intrinsic life time distributions. Comparison of the profiles reveals a factor of difference, F₁=13.0, and factor of similarity, F₂=57.5.

FIG. 6 is a graphical representation of the disintegration and dissolution analysis. The dissolution time-profiles from FIG. 5 are analyzed using the disintegration rate model, which reveals disintegration functions (upper part) and mass distributions between the two log/linearly distributed particle populations (lower part). The left side of FIG. 6 relates to the Test formulation, the right side of FIG. 6 relates to the Reference formulation.

Each FDF is characterized by two PSDs with values for μ and σ of 4.62, 0.74 and 2.51, 0.27 for Test formulation and 3.09, 1.10 and 2.60, 0.04 for Reference, respectively. In Test formulation the first population has a relative weight of 15%, while in Reference formulation the first population is present to 31%.

These results indicate that in the manufacture of the Test formulation, higher pressure could be applied during the tableting, as compared to the Reference formulation, causing longer disintegration of the Test formulation, in which a part of the granular material is crushed to very small particles and the larger part of the dose is compressed to highly heterogeneous and hardly disintegrating aggregates.

Below Table 1 includes a diagnostic tool, S*t_{d}, for disintegration characterization for different disintegration models based on relative rates of FDF disintegration x=vₐ/a₀, y=v_{b}/b₀, z=vₐ/c₀, where a₀, b₀ and c₀ are the initial dimensions of the FDF and vₐ, v_{b} and v_{c} are the disintegration rates along the axis's of the FDF. Included are models where the disintegration rates along two axis follow an exponential function x=vₐ₀*exp(−kₓ*t) and y=v_{b0}*exp(−k_{y}*t) and a special case of bulk erosion where the disintegrated volume follows the differential equation dV/dt=β*V^{2/3}*(1-exp(−t/T) of an FDF having a volume V₀.

Surface erosion

| Parameter | Set1 | Set2 | Set3 | Set4 | Set5 | Set6 | Set7 | Set8 | Set9 |
|---|---|---|---|---|---|---|---|---|---|
| x | 1 | 1 | 1 | 1 | 0.2 | 1 | 1 | 1 | 1 |
| y | 1 | 1 | 0 | 0.2 | 1 | 1 | 0 | 1 | 1 |
| z | 1 | 0 | 0 | 0.2 | 1 | 1 | 0 | 0.2 | 0.2 |
| kₓ | — | — | — | — | — | 0.1 | 0.3 | 0.3 | 0.4 |
| k_{y} | — | — | — | — | — | 0.4 | 0 | 0.3 | 0.4 |
| s*t_{d} | 3.474 | 2.079 | 0.000 | 0.766 | 2.330 | 3.201 | 1.132 | 3.896 | 6.361 |
| R² | 0.998 | 0.998 | 1.000 | 1.000 | 0.998 | 0.999 | 1.000 | 0.999 | 1.000 |

Bulk erosion

| Parameter | Set1 |
|---|---|
| β | 1 |
| τ | 2 |
| V₀ | 10 |
| s*t_{d} | −4.798 |
| R² | 0.996 |

The value of the release coefficient s*t_{d} depends on the actual values of values x, y and z, and eventually β and τ, which indicate the rate constant of forming the channels and of water penetration into to the inner space of the FDF when bulk erosion is modeled. Positive values of s*t_{d} indicate a disintegration process taking place on the surface of the FDF. Its value, when approaching zero indicates that the disintegration takes place along one axis only indicating a highly anisotropic behavior of the process. The actual value s*t_{d} depends not only on the anisotropic/isotropic behavior of the disintegration process, but is influenced by the actual ratios of the FDF shape parameters.

It has to be noted that in case of, e.g., multi-layer tablets, which may contain different qualities of the same API, the general disintegration function considering more PSDs and different disintegration rate functions and different duration for the disintegration of the particular PSDs has to be considered. The method is further described for disintegrated particles following more than one Particle-Size Distributions.

The result of the fitting procedure using the procedure G and the discretely measured dissolution time profiles assuming two populations of particles in the FDF, both following the given disintegration rate function is shown in FIG. 5.

The interpretation of the dissolution time curve analysis in terms of the disintegration function and the distribution of the dose between the two particle size distributions is shown in FIG. 6.

Moreover, particles may follow more PSDs and individual disintegration rate function as a result of heterogeneous distribution of particles in the FDF, e.g., due to multi-layer FDFs.

An implementation of the disintegration and dissolution method into a Physiologically Based Pharmacokinetic (PBPK) model is described. First, a scaling of the model parameters and a mapping of the parameter space is implemented as follows.

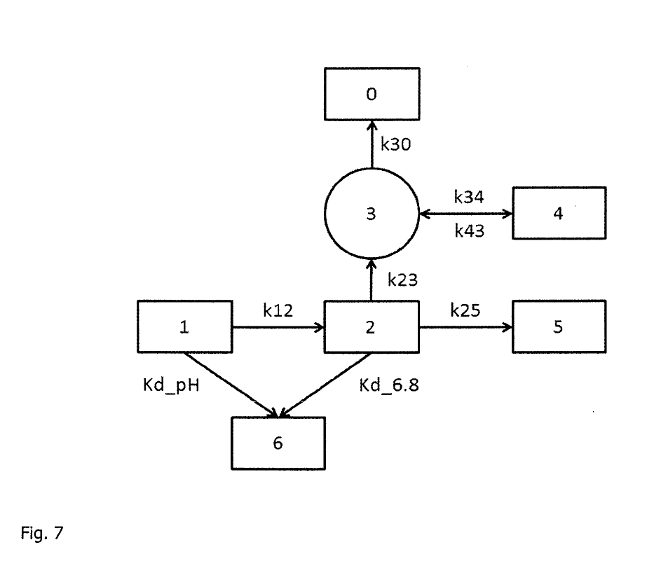

A possible PBPK model is schematically illustrated in FIG. 7. The model includes a compartment 1, which represents the stomach, an absorption window 2, a systemic circulation 3, a deep compartment 4, intestine 5 outside of the absorption window and feces, a loss 6 of drug due to degradation of dissolved API, and an elimination 0 of the drug due to metabolism and urinary elimination.

The compartment 1 is characterized by its initial amount of fluid, stomach juice production which equals to a constant outflow of stomach juice into the compartment 2, then with its pH value causing drug degradation with rate constant Kd(pH) and rate constant of fluid elimination, when there is more than amount characteristic for empty stomach; Compartment 2 is characterized by initial amount of fluid, degradation rate constant of drug (assuming pH of 6.8), rate constant of drug absorption into the systemic circulation and a residence time of its content (T2), the time of spending every portion of entered fluid in the absorption window; Compartment 3 represent the systemic circulation is characterized by its volume V3 and rate constant k34 and k30 describing the flow of drug into the deep compartment 4 and summary rate of hepatic metabolism and urinary elimination, respectively; compartment 4 is characterized by rate constant k43 describing the flow of the drug out of the deep compartment; compartment 5 represent the amount of drug, which was not absorbed in the absorption window; compartment 6 collects the drug degraded either in the stomach or in the absorption window. The disintegration of the FDF, dissolution of the released particles and degradation of dissolved API occurs in compartments 1 and 2. The solubility of the API and decomposition rate constants are pH dependent.

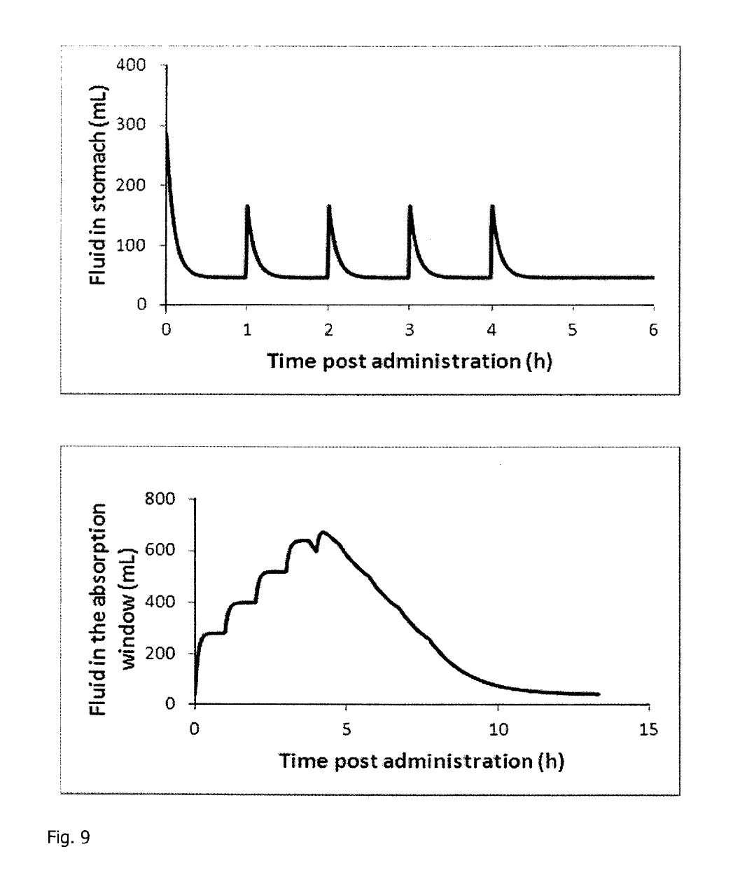

The amounts of fluid in the stomach and in the absorption window were assumed to follow the profiles indicated in FIG. 9. For the current case, the solubility and degradation kinetic data for clarithromycin from Nakagawa et al were used. The data is published by Nakagawa Y, Itai S, Yoshida T, Nagai T 1992, “Physicochemical properties and stability in the acidic solution of a new macrolide antibiotic, clarithromycin, in comparison with erythromycin”, Chem Pharm Bull (Tokyo), 40:725-728.

FIG. 9 shows the assumed time curve of the volume of fluid in the stomach in the left plot in case that the FDF is administered with 240 mL of water and at 1, 2, 3 and 4 hours post administration additional 120 mL of water is provided to the subjects. The resulting amount of fluid in the absorption window is shown in the right plot.

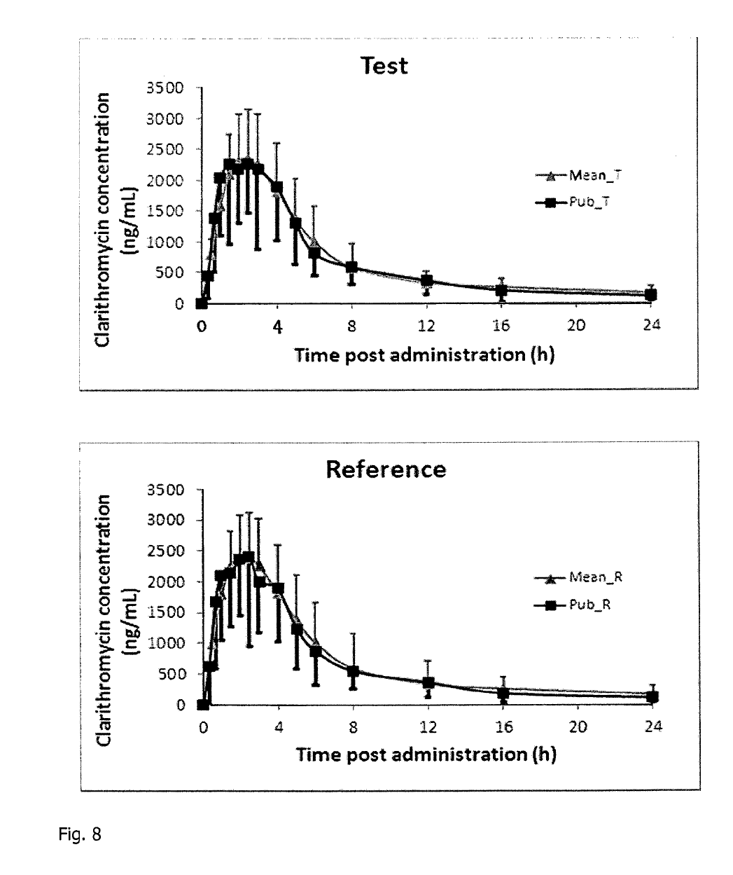

The parameters of the PBPK model are adjusted with the goal to mimic the measured mean plasmatic time profiles of the API, examples of which are shown in FIG. 8.

FIG. 8 shows measured and predicted mean clarithromycin plasma concentrations following an oral administration of a 500 mg immediate release tablet. The measured data is published by Lohitnavy M, Lohitnavy O, Wittaya-areekul S, Sareekan K, Polnok S, Chiyaput W 2003, “Average bioequivalence of clarithromycin immediate released tablet formulations in healthy male volunteers”, Drug Dev Ind Pharm, 29:653-659.

The left plot in FIG. 8 shows in black color mean values of measured clarithromycin plasma concentration with indicated standard deviation values, following the oral administration of the Test formulation. In gray color, the mean value of PBPK model calculations plasma concentrations according to the method of assessing equivalence are indicated (wherein only mean and standard deviation values are indicated). The right plot is the same representation of data for the Reference formulation. The index “Pub” indicates published results, “Mean” represents the arithmetic mean of the data obtained by model prediction using the mean values. The gray error bars represent the variability in plasma concentration caused by variability of investigated parameter determined by Monte Carlo simulation.

By means of the Monte Carlo simulation, the chosen parameters were changed according the formula Parameter=Mean*exp(normal(0,SD)), wherein “Mean” denotes the parameter mean and SD is the standard deviation of the normal distribution:

pH=1.5*exp(normal(0,0.5)),

pH(reference)=pH*exp(normal(0,0.2));

T1=15.25*exp(normal(0,0.3));

T1(reference)=T1*exp(normal(0,0.1));

T2=260*exp(normal(0,0.1)),

T2(reference)=T2*exp(normal(0,0.05)),

k30=0.00845*exp(normal(0,0.25)).

By additional changing the parameters pH, T1 and T2, the intra-individual variability of the system was introduced. The unchanged parameters were taken from the FDF analysis or were optimized in order to minimize the sum of error squares for the reference formulation.

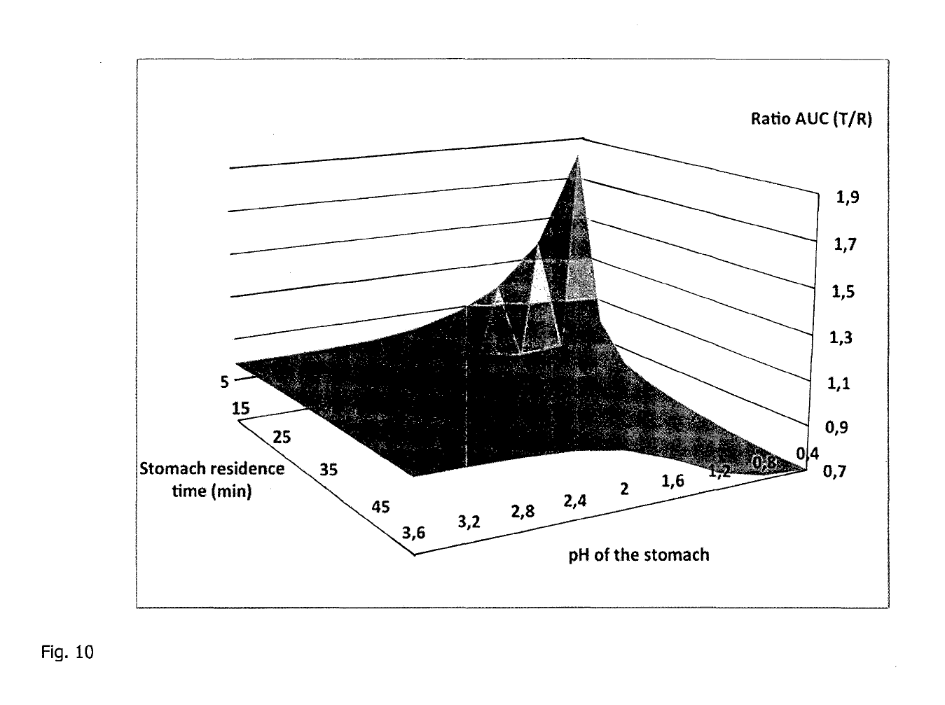

The presented technique can be used for identifying the physiological conditions, under which the Reference FDF and the Test FDF under consideration behave similarly. FIG. 10 shows the effect of stomach pH and stomach residence time on pharmacokinetics of API released from the FDFs under consideration manifested in the ratio of Test to Reference values of AUC and Cmax, respectively. The largest connected region represents the parameter space having the ratios within 90 to 110%.

As shown in FIG. 10, the Test to Reference dependence can be mapped in the plane spanned by stomach residence time and stomach pH. The left plot shows the Area Under the Curve (AUCt), i.e., under the concentration versus time profile. The right plot shows the maximum concentration (Cmax) as determined by using the method of assessing equivalence. The green part of the surface (which is the largest portion of the surface) indicates the region of stomach pH and stomach residence time for which the ratio between Test and Reference formulations lies between 90 and 110%, thus indicating an equivalent behavior of the two formulations.

An implementation of Monte Carlo simulation and assessment of in silico equivalence is described. The generated plasma concentrations were analyzed as data of a performed bioequivalence study. To this end, the AUC and Cmax were calculated using a non-compartmental analysis and the logarithmically transformed values of AUC and Cmax were compared as a two-way crossover study design. The determined 90% confidence intervals (CI) for the presented set of data for AUCt and Cmax are summarized in the following Tables 2 to 4:

Below Table 2 shows results of an in silico equivalence calculation performed for parameter indicated in the legend to FIG. 8:

| | | | Intra-individual |
|---|---|---|---|
| | Point estimate | 90% CI | CV(%) |
| AUCt | 96.55 | 90.81-102.66 | 12.4 |
| Cmax | 95.97 | 90.83-101.40 | 11.1 |

Below Table 3 shows the results of an in silico equivalence calculation, when higher variability (for inter individual and intra individual) was introduced into the Monte Carlo simulation:

| | | | Intra-individual |
|---|---|---|---|
| | Point estimate | 90% CI | CV(%) |
| AUCt | 99.18 | 91.65-107.34 | 16.0 |
| Cmax | 98.45 | 91.06-106.44 | 15.8 |

Below Table 4 shows the results of the maximal variability tested by means of Monte Carlo simulations:

| | | | Intra-individual |
|---|---|---|---|
| | Point estimate | 90% CI | CV(%) |
| AUCt | 93.97 | 84.63-104.34 | 21.4 |
| Cmax | 93.94 | 84.74-104.14 | 21.0 |

All Monte Carlo simulations indicate similar results for the comparison of Test and Reference formulations as published. Table 5 summarizes the published comparison from Lohitnavy M, Lohitnavy O, Wittaya-areekul S, Sareekan K, Polnok S, Chiyaput W 2003, “Average bioequivalence of clarithromycin immediate released tablet formulations in healthy male volunteers”, Drug Dev Ind Pharm, 29:653-659:

| | | | Intra-individual |
|---|---|---|---|
| | Point estimate | 90% CI | CV(%) |
| AUCinf | 99 | 84.7-112 | 28.7 |
| Cmax | 95 | 82.6-112.1 | 31.5 |

The presented technique thus enables an assessment of the in vivo intra-individual variability of the physiological parameters.

Means for numerically representing heterogeneous particles and/or determining the reference dissolution time-profile for heterogeneous particles are provided. The means provided herein below are applicable to dissolution in general. The means are in particular applicable to highly diluted solutions, solutions close to saturation, saturated solutions and supersaturated solutions. The means may be combined with any one of the afore-mentioned methods in the presence of heterogeneous particles.

The methods are in particular applicable to in vivo situations, including situations of precipitation of the API, e.g., due to a change in local temperature or local pH.

Due to the generality of the means for describing the dissolution, implementations may include no limitation to sink condition, no limitation to a specific shape of dissolving particles, no limitation as to a the number of polymorphic forms, no limitation to large initial particles (e.g., compared to the diffusion layer thickness). At least some implementations do not have to account for eventual changes in the particle shape during its dissolution.

A deep understanding of the process of drug dissolution is without doubt essential for the pharmaceutical industry. Conventional dissolution models treat the dissolving system in so called sink conditions, i.e., the effect of drug concentration in the dissolution medium does not significantly influence the dissolution kinetics. With this conventional approach, however, the system properties under saturated conditions cannot be elucidated or numerically described.

Afore-mentioned method of estimation a dissolution profile for polymorphic particles released from disintegrated FDFs is extended by including a diffusion layer model (cf. Wang J, Flanagan D R 1999, “General solution for diffusion-controlled dissolution of spherical particles”, Sect. 1. “Theory”, J Pharm Sci 88:731-738). The models are analysed and applied in sink and non-sink conditions.

The analyses of, and application to, non-sink conditions allows determining changes in dissolution properties of the particles and assessing the increased solubility of the particles when their characteristic dimension is comparable (or lower) than the diffusion layer thickness. This changed properties provide a key for understanding and quantitatively describing the effect of Ostwald ripening, i.e., situations under saturation conditions so that the larger particles grow by taking up mass of small particles. This mechanism thus contributes to a quicker dissolution of the smaller particles.

Means for determining the reference time-profile for an arbitrary particle are provided. Assuming a drug particle of mass m is put into a liquid of volume V The mass of the particle changes according to Eq. (1):

$$\frac{d m}{d t} = - {k}_{1} A + {k}_{2} A \frac{M}{V} \qquad ( 1 )$$

In Eq. (1), k₁ represents the amount of drug dissolved from a unit area within a period of unit time, k₂ is the amount of drug crystallized from a solution of unit concentration to a unit of surface in a unit of time. The surface A and the mass m of an arbitrary particle are expressed by characteristic factors f_{A} and f_{V} as:

A=f_{A}r², and (2)

m=f_{V}r³p (3)

In the Eqs. (2) and (3), r stays for the characteristic dimension of the particle and ρ represents its specific density. Using Eqs. (2) and (3), Eq. (1) can be rewritten into the form

$$\frac{d m}{d t} = - {k}_{1} \frac{{f}_{A}}{{( {f}_{v} ρ )}^{2 / 3}} {m}^{2 / 3} [ 1 - \frac{{k}_{2}}{{k}_{1}} \frac{M}{V} ] . \qquad ( 4 )$$

As detailed in document Wang J, Flanagan D R 1999, “General solution for diffusion-controlled dissolution of spherical particles”, Sect. 1. “Theory”, J Pharm Sci 88:731-738, and in document Wang J, Flanagan D R 2002, “General solution for diffusion-controlled dissolution of spherical particles”, Sect. 2. “Evaluation of experimental data”, J Pharm Sci 91:534-542, the dissolution rate k₁ is not constant and increases as the curvature of the surface decreases. This dependence may be expressed by

$${k}_{1} ( r ) = {k}_{1} ( ∞ ) ( 1 + \frac{δ}{r} ) ,$$

wherein k₁(∞) is the dissolution rate of a plane surface, and δ is the thickness of the diffusion layer. When r is expressed using Eq. (3), the particle mass dependent dissolution rate has a form:

$${k}_{1} ( m ) = {k}_{1} ( ∞ ) [ 1 + \frac{{δ ( {f}_{v} ρ )}^{1 / 3}}{{m}^{1 / 3}} ] . \qquad ( 5 )$$

Substituting Eq. (5) into Eq. (4) results in:

$$\frac{d m}{d t} = - {k}_{1} ( ∞ ) [ 1 + \frac{{h ( {f}_{v} ρ )}^{1 / 3}}{{m}^{1 / 3}} ] \frac{{f}_{A}}{{( {f}_{v} ρ )}^{2 / 3}} {m}^{2 / 3} \{ 1 - \frac{{k}_{2}}{{k}_{1} ( ∞ ) [ 1 + \frac{{h ( {f}_{v} ρ )}^{1 / 3}}{{m}^{1 / 3}} ]} \frac{M}{V} \} . \qquad ( 6 )$$

As defined above, the saturation concentration cis a result of a dynamic equilibrium between dissolution and crystallization, leading to increasing drug solubility with decreasing characteristic dimension of particles.

### Introducing the Symbols

$$a = {k}_{1} ( ∞ ) \frac{{f}_{A}}{{( {f}_{v} ρ )}^{2 / 3}} , \\ β = {h ( {f}_{v} ρ )}^{1 / 3} , and$$

$$c ( ∞ ) = \frac{{k}_{1} ( ∞ )}{{k}_{2}} ,$$

the change of a particle mass is expressed based on Eq. (6) as:

$$\frac{d m}{d t} = - a {m}^{2 / 3} [ 1 + \frac{β}{{m}^{1 / 3}} \frac{M}{c ( ∞ ) V} ] . \qquad ( 7 )$$

The term

$$\frac{β}{{m}^{1 / 3}} in \qquad Eq . ( 7 )$$

increases significantly the dissolution rate of the particle, when its mass decreases below the value β³. Hence, for particles with m<<β³, drug concentration in the dissolution media reaches values which are above the solubility of a plane surfaced drug. In such a case, the saturation concentration c(∞) does not control the dissolution rate of the particle which dissolves with increasing rate.

Alternatively or in addition, when the volume V is very large, the contribution of a dissolved amount of drug originating from a single small particle is negligible. In such a case, the change of particle mass in time is determined only by the external amount of dissolved drug.

For large particles, m>>β³, the influence of β vanishes. For the sink conditions, Eq. (7) becomes

$$\frac{d m}{d t} = - {am}^{2 / 3} \qquad ( 8 )$$

Eq. (7) determines the lifetime of a large particle under sink conditions as

$${t}_{0} ( ∞ ) = \frac{3 {m}_{0}^{1 / 3}}{a} \qquad ( 9 )$$

Solving Eq. (7) for arbitrary particles with initial mass m₀ under sink conditions, under consideration of Eq. (9), the lifetime of such particle is expressed by Eq. (10):

$${t}_{0} ( {m}_{0} ) = {t}_{0} ( ∞ ) [ 1 - {ln ( \frac{1 + \frac{β}{{m}_{0}^{1 / 3}}}{\frac{β}{{m}_{0}^{1 / 3}}} )}^{\frac{β}{{m}_{0}^{1 / 3}}} ] \qquad ( 10 )$$

Assigning x=βm₀^{1/3} for x=0.39795, the lifetime t₀(m₀) reaches 50% of the value of a conventionally determined particle lifetime, i.e., without taking the influence of β into account.

Based on Eq. (7), some more complex cases are defined. In case that one particle dissolves in its own solution, the dissolved amount of the drug is

M=m₀−m,

and Eq. (7) becomes:

$$\frac{d m}{d t} = - {am}^{2 / 3} [ 1 + \frac{β}{{m}^{1 / 3}} - \frac{{m}_{0} - m}{c ( ∞ ) V} ] . \qquad ( 11 )$$

Denoting the initial amount of a solid drug by “Dose”, which is present in a powder in various polymorphic forms, Eq. (7) becomes:

$$\frac{d {m}_{i , j}}{d t} = - {a}_{i , j} {m}_{i , j}^{2 / 3} [ 1 + \frac{β}{{m}_{i , j}^{1 / 3}} - \frac{Dose - {\sum }_{{i}^{′}} {\sum }_{{j}^{′}} {N}_{{i}^{′} , {j}^{′}} {m}_{{i}^{′} , {j}^{′}}}{{c}_{j} ( ∞ ) V} ] \qquad ( 12 )$$

In Eq. (12), the index i indicates a group of the particles defined by their particular initial mass, which group is further distinguished by the particle shape as belonging to a j-th polymorphic form. Each particle kind (i,j) is further characterized by the number of particles Nᵢⱼ of said kind.

Assuming the release of heterogeneous particles from a Finish Dosage Form (FDF), considering additionally a chemical degradation, k_{d}, of the dissolved drug, Eq. (7) changes to

$$\frac{\partial {m}_{i , j} ( t , ξ )}{\partial t} = - {a}_{i , j} {m}_{i , j}^{2 / 3} ( t , ξ ) \{ 1 + \frac{{β}_{i , j}}{{m}_{i , j}^{1 / 3} ( t , ξ )} - \frac{( 1 - {k}_{d} ) [ Dose - {\int }_{0}^{t} {\sum }_{i} {\sum }_{j} {N}_{i , j} {m}_{i , j} ( t , ξ ) v ( ξ ) d ξ ]}{{c}_{j} ( ∞ ) V} \} . \qquad ( 13 )$$

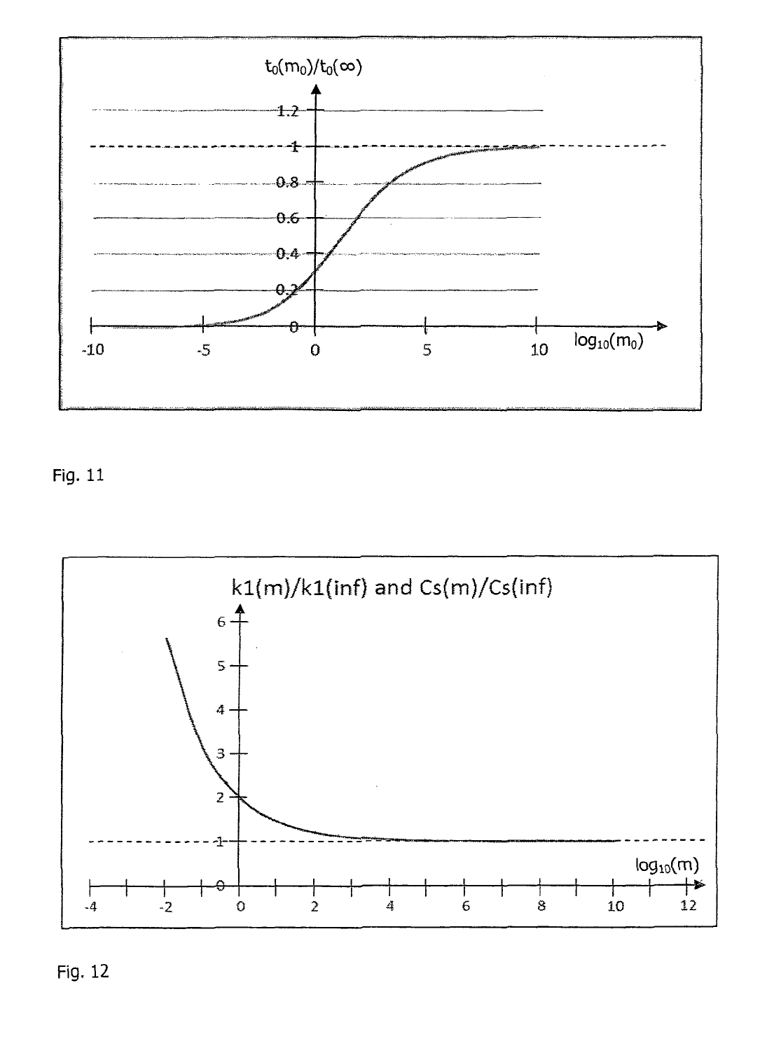

An exemplary dependence of t₀(m₀) under sink conditions in units of t₀(∞) is provided in FIG. 11.

FIG. 11 shows the relative decrease of the lifetime of particles with initial mass m₀. When the particles decrease toward the diffusion layer thickness, their relative life-time decreases to zero, which indicates a significant effect of increased dissolution kinetics and solubility of drug in small particles.

An exemplary dependence of the dissolution rate of the drug, k₁(m), in units of the flat dissolution rate, k₁(∞), is shown in FIG. 12 as a function of the particle mass. The particle mass, m, is shown on the horizontal axis with logarithmic scale.

The dissolution rate, k₁, (per unit of particle surface) and the local solubility, Cₛ, of the drug increases rapidly, if the characteristic dimension of the particle is comparable or decreases below the diffusion layer thickness δ. Both parameters, k₁ and Cₛ, are influenced by the characteristic dimension of the particle in the same way.

Assuming a heterogeneous population of particles of the same polymorphic form, the smaller particles dissolve with higher rate than the larger ones. If the larger ones did not reach the “point of no return”, they will (because of their lower solubility) start to take the dissolved material out of the system. In this way, the larger particles grow for account of the smaller particles, which is the well-known process of Ostwald ripening. Herein, the expression “point of no return” refers to reaching conditions so that the dissolution rate increases independently of the amount of the drug dissolved in the solution.

The means for analyzing and determining the dissolution of heterogeneous particles, e.g., when using a dose leading to the saturation of the system, provides a method for correctly determining drug solubility, which depends on the actual particle size distribution of the API in the experiment.

Systems having two or more polymorphic forms may be described using a known transformation mechanism that transforms polymorphs with higher free energy to more stable forms.

By including a possible chemical instability in the system of equations by the term k_{d} has a significant role in the characterization of APIs under biological conditions in certain situations.

Determination of the solubility of a drug using dissolution of particles can be influenced by the actual particle size distribution of the particles as the amount of dissolved drug is dependent on the ratio h/r.

Generally significant experimental difficulties are reported for solubility measurements due to crystallization of the amorphous drug, and thus, reported experimental solubility ratios may underestimate the true values for these materials, as discussed in Hancock B C, Parks M 2000, “What is the true solubility advantage for amorphous pharmaceuticals?”, Pharm Res 17:397-404. The correct solubility of a polymorphic form may be determined by using above models considering heterogeneous particles.

As has become apparent from above exemplary embodiments of the invention, at least some of the embodiments allow analyzing the dissolution of a finish dosage form, which is numerically represented as a disintegration of the dosage form and a subsequent dissolution of disintegrated particles. When the dissolution time-profile is measured continuously, it is analyzed by numerically solving a Volterra integral equation. When measured at discrete time points, the dissolution time-profile is analyzed by means of a system of differential equations, e.g., employing an FDF disintegration model. Based on the measured dissolution time-profile and on information as to the influence of the physicochemical properties of heterogeneous particle populations (which influence the dissolution kinetics in general), the disintegration rate of the dosage form and the actual physicochemical properties of particles are determined from the measured profiles without the need of having sink conditions.

The information obtained by the analysis technique can be further used for

a) identifying differences in the quality of dosage forms caused by properties of API and/or introduced by the manufacturing processes; and/or
b) implementation into physiologically based pharmacokinetic models providing predictions of the dosage form-dependent variability of drug absorption caused by differences of subjects, thus enabling an in silico equivalence study of the dosage form.

At least some implementations of the technique may thus predict the expected variability in absorption caused by varying physiological conditions in dependence of the properties of the dosage form. Same or other implementations perform in silico comparison of finish dosage forms, thus enabling a reduction of the number of clinical studies needed for understanding the properties of the dosage form and controlling the manufacturing process of the dosage form. The technique can thus reduce the risk of performing non-bioequivalent clinical studies having a financial and ethical impact in the development of dosage forms.

Moreover, the extracted information about the dosage form disintegration kinetics and about properties of the API particle released from the dosage form does allow assessing an expected dosage form-dependent in vivo variability of drug absorption or to assess the impact of differences in the FDF characteristics on in vivo differences in bioavailability of two dosage forms in development (which correlation is also abbreviated by IVIVC) and further to perform in silico-equivalence studies.

All references cited herein are incorporated by reference. While the invention has been fully described, it should be understood that, within the scope of the appended claims, the invention may be practiced departing from the specific details of embodiments. While the invention has been disclosed with reference to its preferred embodiments, from reading this description those of skill in the art may appreciate changes and modification that may be made without departing from the scope of the invention as generally described above and/or claimed hereafter.

1-52. (canceled)

53. A method of estimating a dissolution property of particles released from a dosage form compacted from granular material, the particles including an Active Pharmaceutical Ingredient, API, the method comprising:
measuring a dissolution time-profile for an amount of the API dissolved from the dosage form;
determining a reference dissolution time-profile by integrating a dissolution rate for the API, wherein the dissolution rate depends on one or more parameters indicative of the dissolution property of the particles; and
estimating the dissolution property of the particles by fitting the reference dissolution time-profile to the measured dissolution time-profile, wherein the one or more parameters according to the fitted reference dissolution time-profile represent the estimated dissolution property.

54. The method of claim 53, wherein the dissolution property is an intrinsic property of each of the particles.

55. The method of claim 53, wherein the dissolution property includes an intrinsic dissolution time in an infinite solvent volume for one or for each of a plurality of different particles types.

56. The method of claim 53, wherein the dissolution property includes a dissolution factor for one or for each of a plurality of different particles types.

57. The method of claim 53, wherein the dissolution rate is computed based on
(a) a disintegration rate indicative of a rate at which the particles are disintegrated from the dosage form, and
(b) a particle mass indicative of a mass of a particle, wherein the particle mass at least temporarily decreases or increases after the disintegration of the particle, wherein the decrease or increase depends on the one or more parameters indicative of the dissolution property of the particles.

58. The method of claim 57, wherein the particle mass starts decreasing or increasing at the time of the disintegration.

59. The method of claim 57, wherein the dissolution property includes an initial mass for the decreasing or increasing particle mass for one or for each of a plurality of different particles types.

60. The method of claim 55, wherein the dissolution property includes a dissolution factor, α, which is computed according to
$$α = \frac{D}{δ} \frac{γ}{{ρ}^{2 / 3}} {c}_{s}$$
for a diffusion rate constant D, a thickness δ of the diffusion layer, a specific density ρ of the particle, a geometry factor γ, and a maximum solubility cₛ of the API.

61. The method of claim 57, wherein the dosage form includes a plurality of different particle types, and wherein relative amounts define relative rates at which particles of the different particle types are released from the dosage form, and wherein the disintegration rate defines a total rate at which the particles are released irrespective of the particle types, optionally wherein the fitting also varies the relative amounts for the different particle types.

62. The method of claim 57, wherein the disintegration rate is computed based on the measured dissolution time-profile, optionally wherein a course of the disintegration rate, the disintegration rate at discretized times, an intrinsic dissolution time and/or relative amounts for different particle types are numerically computed.

63. The method of claim 57, wherein the disintegration rate is computed based on a disintegration model.

64. The method of claim 63, wherein the disintegration rate, ν, is determined by a shape parameter, s, according to
$$v ( t ) = \{ \begin{matrix}0 , & t < tlag \\ \frac{s \cdot exp [ - s \cdot ( t - tlag ) ]}{1 - exp [ - s \cdot td ]} , & tlag < t < tlag + td \\ 0 , & t \geq tlag + td\end{matrix} \} ,$$
wherein tlag is a lag time for releasing a particle from the dosage form and td is a duration for releasing a particle from the dosage form, or
wherein the disintegration rate, ν, is determined by a plurality of release shape parameters, sₚ, according to
$$v ( t ) = \{ \begin{matrix}0 , & t < {tlag}_{p} \\ {\sum }_{p = 1}^{L} {r}_{p} \frac{{s}_{p} \cdot exp [ - {s}_{p} \cdot ( t - {tlag}_{p} ) ]}{1 - exp [ - {s}_{p} \cdot {td}_{p} ]} , & {tlag}_{p} < t < {tlag}_{p} + {td}_{p} \\ 0 , & t \geq {tlag}_{p} + {td}_{p}\end{matrix} \} ,$$
wherein tlagₚ is a lag time for releasing a particle of type p from the dosage form and tdₚ is a duration for releasing a particle of type p from the dosage form.

65. The method of claim 57, wherein the computation of the dissolution rate, \dot{M}, is based on a product of the disintegration rate, ν, and the change, ∂m(t,ξ)/∂t, of the particle mass, m, and a degradation rate, k_{d}, optionally according to
$$\dot{M} ( t ) = - {\int }_{0}^{t} {N}_{0} \frac{\partial m ( t , ξ )}{\partial t} v ( ξ ) d ξ - {k}_{d} M ( t ) ,$$
when the particles released from the dosage form are at least substantially uniform.

66. The method of claim 57, wherein the dissolution rate, \dot{M}, is computed based on a product of the disintegration rate, ν, and the change, ∂m(t,ξ)/∂t, of the particle mass and a degradation rate, k_{d}, according to
$$\dot{M} ( t ) = - {\int }_{0}^{t} {\sum }_{p = 1}^{L} {N}_{p 0} \frac{\partial {m}_{p} ( t , ξ )}{\partial t} v ( ξ ) d ξ - {k}_{d} M ( t ) ,$$
when each of the particles released from the dosage form is at least substantially represented by one of a plurality of L particle types, wherein for one or more particle types, p, having a characteristic dimension comparable to or greater than a thickness of a diffusion layer, the change, ∂m(t,ξ)/∂t, of the particle mass, mₚ, is computed according to
$$\frac{\partial {m}_{p} ( t , ξ )}{\partial t} = - {a}_{p} {m}_{p}^{2 / 3} ( t , ξ ) [ 1 + \frac{{β}_{p}}{{m}_{p}^{1 / 3} ( t , ξ )} - \frac{M ( t )}{{c}_{p} ( ∞ ) V} ] ,$$
wherein
$${a}_{p} = {k}_{p , 1} ( ∞ ) \frac{{f}_{p , A}}{{( {f}_{p , V} \cdot {ρ}_{p} )}^{2 / 3}} , \\ {β}_{p} = {δ}_{p} \cdot {( {f}_{p , V} \cdot {ρ}_{p} )}^{1 / 3} , \\ {c}_{p} ( ∞ ) = \frac{{k}_{p , 1} ( ∞ )}{{k}_{p , 2}} ,$$
with k_{p,1}(∞) being a dissolution rate of a plane surface, δₚ is the thickness of the diffusion layer, k_{p,2} is a crystallization rate, f_{p,A} is a surface factor, and fₚ, γ is a volume factor, and wherein each particle type is associated with a solubility cₚ(∞).

67. The method of claim 53, wherein the dissolution rate, \dot{M}, is computed based on a product of the disintegration rate, −∂V_{F}(ξ)/∂ξ, and the change, ∂m(P,t,ξ)/∂t, of the particle mass and a degradation rate, k_{d}, according to
$$\dot{M} ( t ) = {\int }_{0}^{t} d ξ {\int }_{0}^{∞} d P n ( P , ξ ) \frac{\partial {V}_{F} ( ξ )}{\partial ξ} \frac{\partial m ( P , t , ξ )}{\partial t} - {k}_{d} M ( t ) ,$$
wherein the change of the particle mass is parameterized by at least one of the one or more parameters P.

68. The method of claim 67, wherein the change of the particle mass is parameterized by an intrinsic dissolution time T₀ in an infinite solvent volume for one or for each of a plurality of different particles types, and wherein the dissolution property includes the intrinsic dissolution time.

69. The method of claim 65, wherein the computation of the dissolution rate, \dot{M}(t), further includes a degradation term
−k_{d}·M(t),
wherein k_{d} is a rate of API degradation, optionally wherein the API degradation rate, k_{d}, is a function of a pH value of a solvent.

70. The method of claim 52, wherein the fitting includes comparing the measured dissolution time profile and the reference dissolution time profile;
adjusting the one or more parameters based on a result of the comparison to reduce a deviation between the measured dissolution time profile and the reference dissolution time profile; and
repeating the steps of determination, comparison and adjustment until the result of the comparison fulfils a matching criterion.

71. A computer-implemented method of assessing equivalence between a dosage form and a given second dosage form, the method comprising:
providing a Physiologically Based Pharmacokinetic, PBPK, model; and
estimating a dissolution property of particles released from the dosage form according to claim 1, wherein the measured dissolution time-profile, M_{measured}(t), is incompletely represented by one or more measured plasmatic time-profiles for the given second dosage form, and wherein the reference dissolution time-profile, M(t), is computed under conditions defined by the PBPK model.

72. The method of claim 71, wherein the PBPK model includes a fluid intake regime and the reference dissolution time-profile, M(t), is computed for the fluid intake regime, wherein the dissolution property is estimated for different combinations of pH values and residence times of the fluid intake regime.
